(19) United States
(12) Patent Application Publication
(10) Pub. No.: US 2016/0214457 A1
(43) Pub. Date: Jul. 28, 2016

(54) HEAT EXCHANGER FOR EXCHANGING HEAT BETWEEN A HEAT-TRANSFER LIQUID AND A REFRIGERANT, IN PARTICULAR FOR A MOTOR VEHICLE

(71) Applicant: VALEO SYSTEMES THERMIQUES, LE MESNIL SAINT-DENIS (FR)

(72) Inventors: Christophe Denoual, Noyen Sur Sarthe (FR); Alain Pourmarin, La Suze-Sur-Sarthe (FR)

(73) Assignee: Valeo Systemes Thermiques, Le Mesnil Saint Denis (FR)

(21) Appl. No.: 14/653,353

(22) PCT Filed: Dec. 12, 2013
(86) PCT No.: PCT/EP2013/076411

§ 371 Date: Jun. 18, 2015

(30) Foreign Application Priority Data
Dec. 21, 2012 (FR) 1262623

(51) Int. Cl. B60H 1/00; F28D 9/00; F28F 9/00

(52) U.S. Cl. CPC B60H 1/00342; F28F 9/001; F28F 9/005; F28D 9/0043

(57) ABSTRACT

A heat exchanger for exchanging heat between a heat-transfer liquid and a refrigerant, in particular for a motor vehicle, is disclosed. The heat exchanger includes a housing and a unit for circulating the refrigerant, and defining blades for circulating the refrigerant superposed in a stacking direction, where the unit is disposed in the housing. The heat exchanger is configured to define a circuit for the flow of said heat-transfer liquid in the housing between the blades, such that a heat exchange can take place between the heat-transfer liquid and the refrigerant.

The invention relates to a heat exchanger for exchanging heat between a heat-transfer liquid and a refrigerant. It is particularly intended to allow reheating and/or cooling of said heat-transfer liquid, depending on the state of said refrigerant.

In the automotive field, when vehicles have a combustion engine it is traditional to use the heat released by the engine to heat the vehicle interior. In hybrid and/or electric vehicles, it is known that the heat released by the engine is sometimes inadequate and alternative solutions have to be found to heat the vehicle interior.

A first solution is to use electric radiators supplied by the vehicle battery, but this shortens the battery's operating life.

Another solution is to run the vehicle's air-conditioning system in heat pump mode. In other words, refrigerant running through said circuit is used to make heat pass from the outside of the vehicle towards the inside thereof. It is known in this context for heat exchangers to be used, enabling there to be an exchange between the refrigerant and a heat-transfer liquid. Said heat-transfer liquid is then used to heat the interior of the vehicle.

Heat exchangers of this kind take the shape of brazed exchangers in which refrigerant circulation channels and heat-transfer liquid circulation channels are alternatively defined by stacked plates.

A configuration of this kind has its advantages but proves complex due to the number of components used. Moreover, the brazed nature of the exchanger limits the positioning possibilities of the input and/or output flanges of the fluids circulating in the exchanger, as well as the mounting flanges of the exchanger, such that the integration thereof in the vehicle is made complex. External corrosion is likewise observed.

The aim of the invention is to mitigate the aforementioned disadvantages and propose in this respect a heat exchanger for exchanging heat between a heat-transfer liquid and a refrigerant, particularly for a motor vehicle, said heat exchanger comprising a housing and a unit for circulating the refrigerant, defining blades for circulating said refrigerant superposed in a stacking direction, said unit being disposed in said housing, said heat exchanger being configured to define a circuit for the flow of said heat-transfer liquid in said housing between said blades, such that a heat exchange can take place between the heat-transfer liquid and the refrigerant.

By using a housing of this kind to circulate the heat-transfer liquid, the number of components is limited, since it is no longer necessary to provide a plurality of plates for the corresponding circuit. Moreover, the possibilities for integrating fluid input and/or output interfaces, as well as mounting flanges which can be connected to or derived from housing material, are increased. Moreover, a standard unit can be used to circulate the refrigerant and a housing that can be adapted to the differing configurations found from one vehicle to the next. Said housing may likewise enable external corrosion to be withstood more effectively.

Moreover, the opportunity to keep a circulation unit for the refrigerant makes it possible to limit the risks for a fluid of this kind resulting from tough operating conditions, particularly in terms of pressure.

According to different embodiments, which can be taken together or individually:
said housing is configured to guide said unit during assembly of the heat exchanger,
said housing comprises a first and a second part, defining an internal volume on the inside whereof said circulation blades for the refrigerant are situated,
said first part is formed from a box and said second part is formed from a closing cover of said box,
said closing cover comprises a recess and said box is fixed in said recess,
said box comprises input and/or output tubes for the heat-transfer liquid and/or said cover comprises openings for the flow-through of said heat-transfer liquid,
said input and/or output tubes are derived from material of said box,
said heat exchanger comprises mounting flanges derived from said box and/or said cover,
said first and second parts are each formed from a shell, said shells being joined to one another,
said shells are joined in said stacking direction,
said shells are joined in a direction perpendicular to said stacking direction,
said unit comprises an input and/or output window for the refrigerant in a direction substantially perpendicular to said stacking direction,
each of said shells comprises a raised edge for joining to the other of said shells by means of at least one mounting flange,
one of the parts comprises input and/or output tubes for the heat-transfer liquid and/or the other of the parts comprises input and/or output tubes for the refrigerant,
said input and/or output tubes are derived from material of said shells,
said box and/or said shells are made of plastics material and/or said cover of metallic material,
said housing comprises at least one internal partition intended to make said heat-transfer liquid circulate in a plurality of channels and/or rows,
said blades extend in a longitudinal direction perpendicular to the stacking direction,
said unit comprises collectors for the refrigerant situated at the level of a longitudinal end edge of the blades, referred to as blade heads,
said unit comprises plates stacked in said stacking direction, said plates being associated in pairs to define said circulation blades of the refrigerant,
said unit comprises fluid links between the plates of the pairs of plates situated at the level of said blade heads, in such a manner as to form said collectors,
said fluid links comprise pressings derived from said plates, said pressings coming into contact with the pressings of the plate facing the neighboring pair of plates for circulation of the refrigerant,
said unit is provided with first turbulators between said pairs of plates,
said unit is provided with second turbulators between the plates of a same pair of plates,
said unit exhibits an open lateral face between said blades on the longitudinal end side of said blades opposite that provided with said collectors,
said blades are configured to make the fluid between a first of said collectors and a second of said collectors make a U-shaped circuit.

These characteristics and others of the present invention are illustrated below with reference to the attached drawings in which:

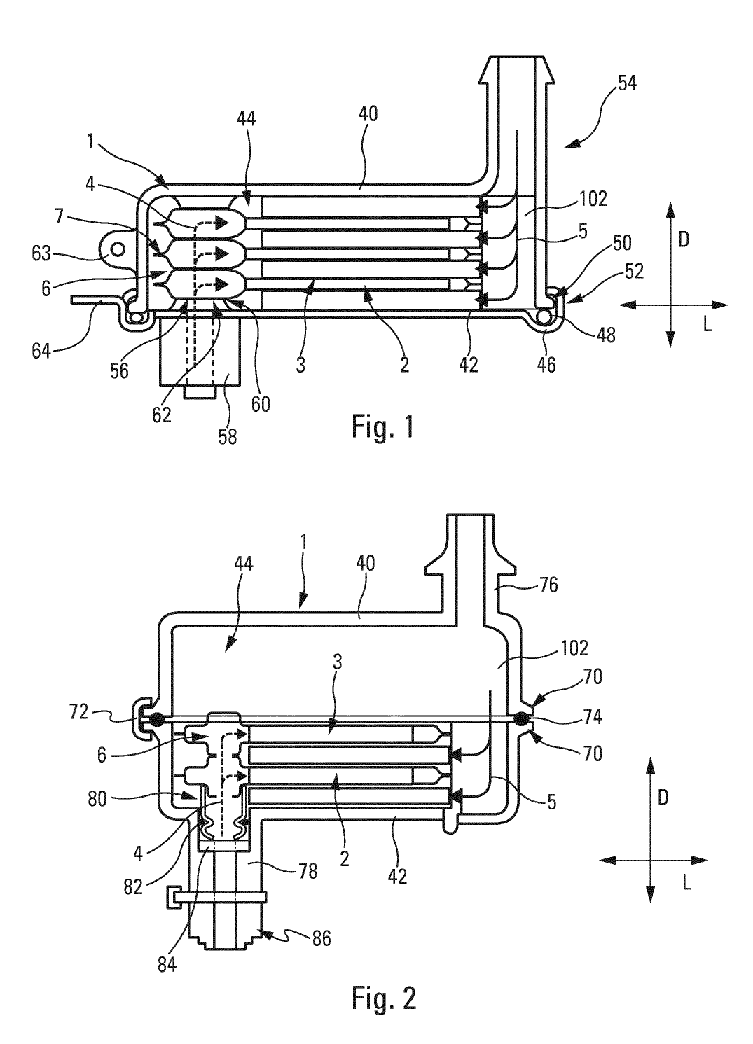

FIG. 1 is a sectional view of a first embodiment of a heat exchanger according to the invention;

FIG. 2 is a sectional view of a second embodiment of a heat exchanger according to the invention;

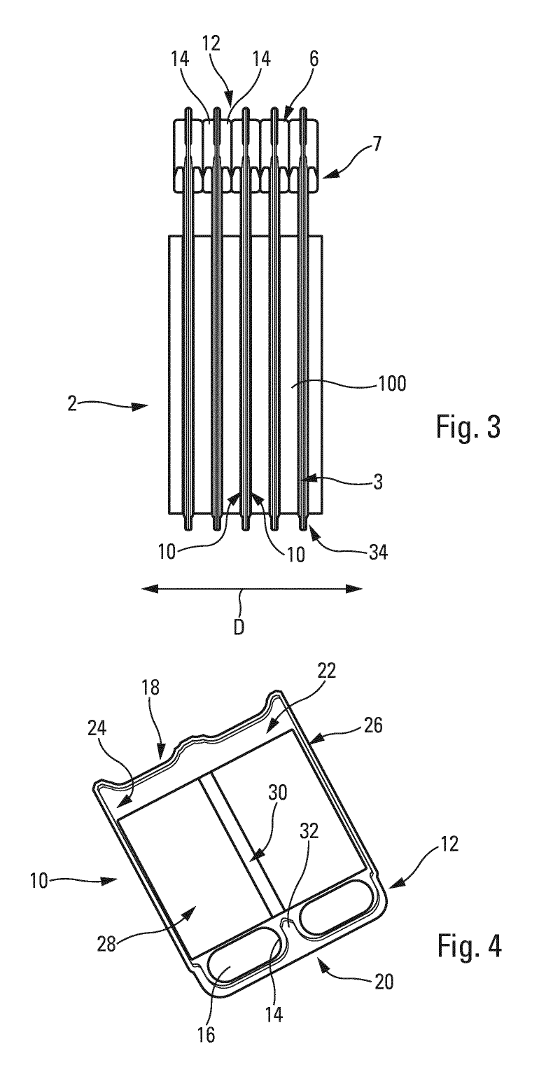

FIG. 3 is a side view of a fluid circulation unit capable of being used in the exchanger in FIGS. 1 and 2;

FIG. 4 is a perspective view of a plate of the circulation unit in FIG. 3;

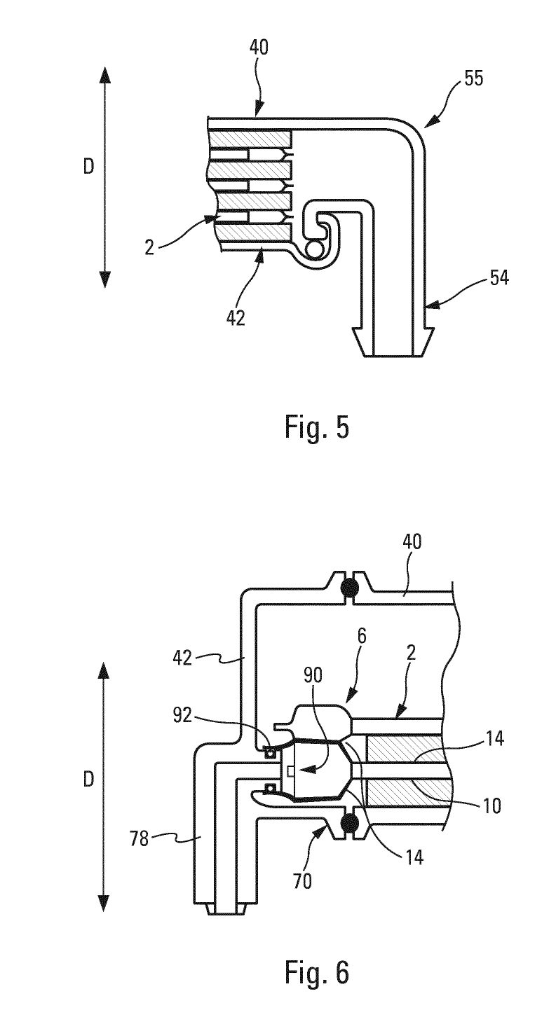

FIG. 5 is a sectional view partly illustrating a variant of the embodiment according to the invention of the heat exchanger in FIG. 1;

FIG. 6 is a sectional view partly illustrating a variant of the embodiment according to the invention of the heat exchanger in FIG. 2;

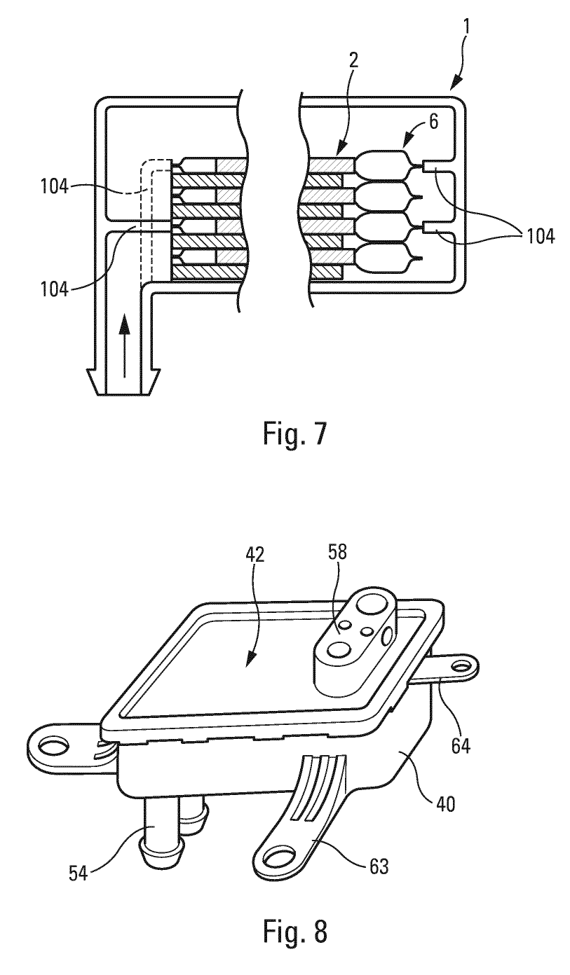

FIG. 7 is a sectional view of a third embodiment of a heat exchanger according to the invention;

FIG. 8 is a perspective view of the heat exchanger in FIG. 1.

In the following description, identical reference numbers are used to denote similar or identical elements.

As illustrated in FIGS. 1 and 2, the invention relates to a heat exchanger for exchanging heat between a heat-transferring liquid and a refrigerant, particularly for a motor vehicle.

Said heat exchanger will be able to be used, in particular, as a heating and/or cooling radiator for said heat-transfer liquid, depending on the state of said refrigerant. Said heat-transfer liquid is water, for example, particularly ethylene glycol-water. Said refrigerant is, for example, the refrigerant known by the name R134a or also R1234yf. However, other applications are possible.

Said heat exchanger comprises a housing 1 and a unit 2 for circulating the refrigerant. Said unit 2 defines blades 3 for circulating said refrigerant superposed in a stacking direction D. Said unit 2 is partly illustrated in FIG. 2. The refrigerant is circulated in this case according to the arrows labelled 4. Said unit 2 is disposed in said housing 1.

According to the invention, said device is configured to define a circuit for the flow of said heat-transfer liquid, according to the arrows labelled 5, in said housing 1 between said blades 3, so as to allow a heat exchange between the heat-transfer liquid and the refrigerant. In other words, the refrigerant circulates in the unit 2 which is bathed in the heat-transfer liquid circulating in the housing 1.

In this way, a heat exchange configuration is obtained which involves components, namely the housing 1 for the heat-transfer liquid and the unit 2 for the refrigerant, adapted to the specific constraints of each of the fluids. Hence, a reliable heat exchange takes place at no additional cost. The use of a housing 1 will moreover allow easier integration of the fluid connection and/or the heat exchanger attachment interfaces, as well as improving the resistance thereof to external corrosion.

Said unit 2 is formed, for example, from components made of aluminum and/or aluminum alloy. It can be joined by brazing said components, for example.

Said blades 3 extend in this case in a longitudinal direction L, perpendicular to the stacking direction D. Said unit 2 may comprise collectors 6 for circulating the refrigerant in said blades 3. Said collectors 6 are situated, for example, at the level of a longitudinal end edge 7 of the blades 3, referred to as the blade head.

Said blades 3 are configured in this case to make said fluid between a first and a second of said collectors 6 make a U-shaped circuit. The first of the collectors 6 therefore constitutes an input collector for the fluid, whereas the second of the collectors constitutes an output collector for said fluid. In other words, the fluid circulates in the unit 2, being distributed by the input collector 6 in the blades 3 where it follows the U-shaped circuit produced higher up, after which it enters the output collector 6.

As clearly emerges from FIGS. 3 and 4, said unit 2 comprises in this case plates 10 stacked in said stacking direction D, said plates 10 being associated in pairs to define said blades 3 used to circulate the refrigerant. According to other embodiments, said blades can be defined by extruded tubes, bent tubes or any other means allowing a fluid to be guided. Said pairs of plates 10 are advantageously identical to one another.

Said exchanger comprises fluid links 12 between the plates 10 in the pairs of plates, situated at the level of said plate heads 7, in such a manner as to form said collectors 6.

Said fluid links 12 comprise, for example, pressings 14 derived from said plates 10, said pressings 14 coming into contact with the pressings 14 of the plate facing the neighboring pair of plates 10. Said pressings 14 are provided with an opening 16 for the flow of fluid. In this way, said pressings 14 allow the circulation of fluid from one pair of plates to the other by connecting said openings 16. Said pressings 14 of a same collector 6 are situated in this case in the axial extension of each other, such that said collectors 6 are substantially rectilinear.

Said plates 10 comprise a longitudinal end edge 18, referred to as distal, opposite a longitudinal end edge 20 of said plates, at the level whereof are situated said fluid links 12.

Said plates 10 comprise a base 22, a raised edge 24 and a brazing lip 26. Said pairs of plates are formed by two of said plates 10, intended to be identical, mounted head to tail, such that their lips 26 are in contact. Each of said pairs of plates 10 comprises a conduit for the U-shaped circulation of the fluid, between said collectors 6.

Said blades 10 may comprise a disruptor 28 of the refrigerant flow. In this case, said disruptors define longitudinal circulation channels of said fluid.

According to an embodiment that is not shown, said disruptors are localized deformations on at least one of the plates 10 delimiting a fluid circulation conduit. Deformations of this kind are preferably pressings realized in conjunction with pressings 14 defining in part said fluid links 12.

According to a variant which is not illustrated, the U-shaped circulation sought after is obtained by a pressed form of the base of the plates, such as a central partial groove leaving longitudinal end edges provided with linking pressings 14.

According to another variant corresponding to the heat exchanger shown, the input collectors 6 open out facing a first part of the disruptor channels 28, whereas the output collector opens out facing a second part of the channels, separated from said first part of the channels by one or a plurality of central channels 30. Moreover, said plates 10 comprise locking pressings 32 between the linking pressings 14, closing the central channel or channels 30 at one of its/their longitudinal ends.

Said disruptors 28 are advantageously shorter than the base 22 of said plates 10, so as to define a U-shaped zone for the refrigerants in each of the pairs of plates.

Said unit 2 may be provided with disruptors 100 between said pairs of plates 10, said disruptors 100 being intended to be crossed by said heat-transfer liquid.

Said unit 2 exhibits internal blade 3 heights of 1 to 1.5 mm, for example, for circulation of the refrigerant and/or heights between pairs of blades 3 of between 2 and 4 mm, for example, for circulation of the heat-exchange liquid.

Said unit 2 exhibits an open lateral face 34 between said blades 3 on the longitudinal end side of said blades opposite that provided with said collectors 6.

If FIGS. 1 and 2 are referred to again, it can be seen that said housing 1 comprises a first 40 and a second 42 part defining an internal volume 44 on the inside of which said blades 3 for circulating refrigerant are situated. In this way, assembly of the unit 2 is made possible. Said housing 1 may be configured in this respect to guide said unit 2 during the assembly of the heat exchanger.

As illustrated in FIG. 1, according to a first exemplary embodiment, said first part 40 is formed from a box and said second part 42 is formed from a closing cover of said box. Said box 40 is made of plastics material, for example, and/or said cover 42 is made of metallic material, for example, particularly aluminum and/or aluminum alloy.

In this case, said closing cover 42 comprises a recess 46 and said box 40 is fixed in said recess 46. Said housing 1 may, moreover, comprise a gasket 48, situated in said recess 46. Said box 40 advantageously exhibits a box foot 50 along an edge of said box 40, said gasket 48 being compressed in said recess 46 by said box foot 50. Said cover 42 is, for example, crimped on said box 40, in this case by crimping teeth 52 cooperating with said box foot 50.

Said box 40 comprises, for example, input and/or output tubes 54 for the heat-transfer liquid. Said input and/or output tubes 54 are advantageously derived from material of said box 40.

Said cover 42 comprises on its side openings 56 for the flow of said refrigerant. Said flow openings are situated, for example, at the level of pressings 60 made in said cover to come into contact with said collectors 6 of the unit 2, such that the refrigerant circulates in a cavity 62 defined by said cover 42 pressings 60 on entering or leaving said collectors 6. In this case, said exchanger moreover comprises an input and/or output flange 58 for refrigerant fixed on the cover 42 facing flow openings 56 and cavities 62.

Said housing 1 may, moreover, comprise mounting flanges 63, 64 on said box 40 and/or on said cover 42 advantageously derived from material of the latter. A housing 1 of this kind is illustrated on the outside in FIG. 8.

FIG. 5 illustrates a similar embodiment, except for the difference in orientation of at least one of the input/output tubes 54 of the liquid. In FIG. 1, the tube or tubes 54 are derived from a face of the box 40 opposite the cover 42, moving away from said cover 42, whereas in FIG. 5, the tube or tubes 54 form an elbow 55 when approaching said cover 42.

As illustrated in FIG. 2, according to a different embodiment, said first and second parts are each formed from a shell 40, 42, said shells being joined to one another. Said shells 40, 42 are made of plastics material, for example.

Each of said shells 40, 42 in this case comprises a raised edge 70 for joining to the other said shells. Said raised edges 70 are joined one against the other, for example, according to a plane-to-plane contact.

Said shells 40, 42 are joined to one another, for example by adhesion, sealing and/or welding, particularly by ultrasound. They may likewise be joined by means of locking flanges 72, a gasket 74 being provided between said shells 40, 42, in this case between their raised edges 70.

One 40 of the shells comprises input and/or output tubes 76 for the heat-transfer liquid and/or the other 42 of the shells comprises input and/or output tubes 78 for the refrigerant, advantageously derived from material of said shells.

Said heat exchanger may, moreover, comprise flanges 80 for connecting to the unit 2, particularly at the level of an axial end of said collectors 6, for circulation of the refrigerant. Said flanges 80 for connection to the unit 2 are positioned in said corresponding input/output tubes 78, where necessary with the help of a gasket 82 guaranteeing tightness between the internal volume 44 of the housing 1 and a conduit 84 defined by said input/output tubes 78 of the fluid. Said flanges 80 for connecting to the unit 2 establish a leak-proof fluid communication between said conduits 84 and said unit 2. Said input/output tubes 78 of the fluid may, moreover, receive quick-connection means 86. The input and/or output tubes 76 for the heat-transfer liquid may likewise receive quick-connection means (not shown).

In FIG. 2, said shells 40, 42 are joined in said stacking direction D. In other words, the contact plane of the raised edges 70 is at right angles to said stacking direction D. Moreover, the refrigerant is introduced into the unit 2 in a direction parallel to said stacking direction.

Alternatively, in FIG. 6 said shells 40, 42 are joined in a direction perpendicular to said stacking direction. In other words, the contact plane of the raised edges 70 is parallel to said stacking direction D. Moreover, the refrigerant is introduced into the unit 2 in a direction at right angles to said stacking direction.

Said unit 2 comprises in this case a window 90 for the input and/or output of the refrigerant in a direction substantially at right angles to said stacking direction D, at the level of one and/or the other of said collector boxes 6, more accurately of the pressings 14 of the blades 10 of a same pair of blades. A connection to said input/output tubes 78 of the fluid is established, for example, according to a solution similar to that of the embodiment in FIG. 2, with the help of a connection flange 92. Said input/output tubes 78 for the fluid are bent in this case.

In this variant, said shells 40, 42 are joined to one another, for example, at the level of interface zones between the blade heads and a heat-exchange part of said blades 10.

This being the case, said housing 1 is configured to make said heat-transfer liquid circulate in a plurality of channels. It may thereby comprise an internal partition 102 to ensure U-shaped circulation of the heat-transfer liquid between the input and output tubes 54, 76 of the heat-transfer liquid. The latter is advantageously achieved against the current of the U-shaped circulation organized in the blades 3 of the unit 2.

FIG. 7 shows an example of a housing 1 allowing circulation in a plurality of rows and, in each row, in a plurality of channels, thanks to different internal partitions 104 formed in a wall of said housing 1.

1. A heat exchanger for exchanging heat between a heat-transfer liquid and a refrigerant for a motor vehicle, said heat exchanger comprising:
a housing; and
a unit for circulating the refrigerant, defining blades for circulating said refrigerant superposed in a stacking direction, said unit being disposed in said housing,
said heat exchanger being configured to define a circuit for the flow of said heat-transfer liquid in said housing between said blades, such that a heat exchange can take place between the heat-transfer liquid and the refrigerant.

2. The heat exchanger as claimed in claim 1, wherein said housing comprises a first and a second part, defining an internal volume on the inside whereof said circulation blades for the refrigerant are situated.

3. The heat exchanger as claimed in claim 2, wherein said first part is formed from a box and said second part is formed from a closing cover of said box.

4. The heat exchanger as claimed in claim 3, wherein said closing cover comprises a recess and said box is fixed in said recess.

5. The heat exchanger as claimed in claim 4, wherein said box comprises input and/or output tubes for the heat-transfer liquid and/or said cover comprises openings for the flow-through of said heat-transfer liquid.

6. The heat exchanger as claimed in claim 2, wherein said first and second parts are each formed from a shell, said shells being joined to one another.

7. The heat exchanger as claimed in claim 6, wherein said shells are joined in said stacking direction.

8. The heat exchanger as claimed in claim 6, wherein said shells are joined in a direction perpendicular to said stacking direction.

9. The heat exchanger as claimed in claim 8, wherein said unit comprises an input and/or output window for the refrigerant in a direction substantially perpendicular to said stacking direction.

10. The heat exchanger as claimed in claim 6, wherein each of said shells comprises a raised edge for joining to the other of said shells by means of at least one mounting flange.

11. The heat exchanger as claimed in claim 5, wherein one of the parts comprises input and/or output tubes for the heat-transfer liquid and/or the other of the parts comprises input and/or output tubes for the refrigerant.

12. The heat exchanger as claimed in claim 3, wherein said box and/or said shells are made of plastics material and/or said cover of metallic material.

13. The heat exchanger as claimed in claim 1, wherein said housing comprises at least one internal partition intended to make said heat-transfer liquid circulate in a plurality of channels and/or rows.

14. The heat exchanger as claimed in claim 1, wherein said blades extend in a longitudinal direction perpendicular to the stacking direction and said unit comprises collectors for the refrigerant situated at the level of a longitudinal end edge of the blades, referred to as blade heads.

15. The heat exchanger as claimed in claim 1, wherein said unit comprises plates stacked in said stacking direction, said plates being associated in pairs to define said circulation blades of the refrigerant.
